(19) United States
(12) Patent Application Publication
(10) Pub. No.: US 2007/0075933 A1
(43) Pub. Date: Apr. 5, 2007

(54) Plasma display panel and method of driving the same

(75) Inventor: Kota Araki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/529,521

(22) Filed: Sep. 29, 2006

(30) Foreign Application Priority Data
Sep. 29, 2005 (JP) 2005-284548

(51) Int. Cl. G09G 3/28

(52) U.S. Cl. 345/67

(57) ABSTRACT

A method of driving a plasma display panel including (a) a first electrode, (b) a second electrode extending in parallel with the first electrode to define a display line therebetween, and (c) a third electrode extending crossing with the first and second electrodes, display cells being defined at intersections of the first and second electrodes with the third electrode, display control being carried out to the display cells in dependence on whether there occurs electric discharge caused by applying a selection pulse to the first and third electrodes in a scanning period, the method including providing a fourth electrode which causes preliminary electric discharge together with one of the first, second and third electrodes, and keeping the preliminary electric discharge caused during a discharge period for at least two display lines in the scanning period.

### BACKGROUND OF THE INVENTION

1. Field of the Invention

The invention relates to a plasma display panel, a method of driving the same, and a plasma display unit including the same.

2. Description of the Related Art

A plasma display panel is structurally grouped into a DC type plasma display panel in which electrodes are exposed to discharge gas, and an AC type plasma display panel in which electrodes are covered with a dielectric film, and accordingly, are not exposed to discharge gas. An AC type plasma display panel is further grouped into a memory operation type plasma display panel making use of memory operation caused by the dielectric film accumulating electric charges, and a refresh operation type plasma display panel not making use of the above-mentioned memory operation.

Hereinbelow are explained an AC type plasma display panel and a process of driving a memory operation type plasma display panel.

FIG. 1 is an exploded perspective view of a conventional plasma display panel. Such a plasma display panel is suggested in Japanese Patent Application Publication No. 2001-272948.

The illustrated plasma display panel 15 is comprised of an electrically insulating front substrate 1A, and an electrically insulating rear substrate 1B facing the front substrate 1A.

The front substrate 1A is formed on a surface thereof facing the rear substrate 1B with a scanning electrode 2 and a sustaining electrode 3 spaced away from each other by a certain distance and extending in parallel with each other.

Each of the scanning electrode 2 and the common electrode 3 is comprised of a bus electrode 2B, 3B providing electrical conductivity, and a primary discharge electrode 2A, 3A formed on the bus electrode 3A, 3B and causing electric discharge. The primary discharge electrode 2A, 3A is composed of transparent material such as ITO (Indium-Tin Oxide) or SnO₂ for preventing reduction in light-transmittance.

A dielectric layer 7A is formed on the front substrate 1A, covering the scanning electrode 2 and the sustaining electrode 3 therewith. The dielectric layer 7A is covered with a protection layer 9 for protecting the dielectric layer 7A from electric discharges.

The protection layer 9 further has a function of emitting electrons when ions generated by electric discharges bombard to the protection layer 9, for making it easy to cause electric discharges.

In light of the above-mentioned two purposes, the protection layer 9 is composed of magnesium oxide (MgO), for instance. Electrons emitted when ions bombard to the protection layer 9 are called secondary electrons.

The rear substrate 1B is formed on a surface thereof facing the front substrate 1A with a plurality of address electrodes 4 extending in a direction perpendicular to a direction in which the scanning electrode 2 and the sustaining electrode 3 extend. The address electrodes 4 are equally spaced away from one another, and extend in parallel with one another.

A dielectric layer 7B is formed on the rear substrate 1B, covering the address electrodes 4 therewith. On the dielectric layer 7B is formed a plurality of partition walls 6A extending in parallel with the address electrodes 4. The partition walls 6A define a discharge space between the first and second substrates 1A and 1B, and the partition walls 6A located adjacent to each other define a display cell therebetween.

Fluorescent material 8 is coated on sidewalls of the partition walls 6A and an exposed surface of the dielectric layer 7B. The fluorescent material 8 converts ultra-violet rays generated by discharges, into visible lights. For instance, red, green and blue (RGB) fluorescent materials are coated every three cells, ensuring displaying color images.

Discharge gas spaces sandwiched between the front and rear substrates 1A and 1B and further between adjacent partition walls 6A are filled with discharge gas comprised of helium, neon or xenon alone or in combination, for instance.

FIG. 2 is a plan view of the plasma display panel 15 viewed through a display screen thereof.

As illustrated in FIG. 2, the scanning electrode 2 and the sustaining electrode 3 extend in a row direction in parallel with each other.

A gap 10 formed between the scanning electrode 2 and the sustaining electrode 3 is called a discharge gap. Surface electric discharges are generated in the discharge gap 10 between the scanning electrode 2 and the sustaining electrode 3.

Hereinbelow is explained a probability at which electric discharge is generated.

In order to generate electric discharge between electrodes in a display cell, it is necessary to apply a voltage beyond a threshold voltage across the electrodes.

It takes some time after a voltage was applied across the electrodes, until electric discharge is generated. Such time is called discharge-delay time.

Discharge-delay time is determined as probable time in view of various parameters of a plasma display panel. An important parameter is a density of electrically charges particles and metastables in a discharge space. Such electrically charges particles and metastables are called priming particles. A greater number of priming particles would present a higher discharge probability.

Hereinbelow is explained discharge operation to be carried out in a selected display cell.

Electric discharge is generated by applying a pulse voltage which is beyond a threshold voltage, across the scanning electrode 2 and the address electrode 4 in each of display cells. Then, positive and negative electric charges are attracted to surfaces of the dielectric layers 7A and 7B in dependence on polarity of the pulse voltage, and thus, positive and negative electric charges are accumulated on the dielectric layers 7A and 7B.

A wall voltage defined as an equivalent internal voltage caused by accumulation of electric charges has a polarity opposite to that of the pulse voltage. Accordingly, as electric discharge grows, an effective voltage lowers in a display cell. Thus, even if the pulse voltage is kept constant, it would not be possible to keep generating electric discharges, resulting in termination of electric discharges.

If a voltage beyond a predetermined level is applied across the scanning electrode 2 and the sustaining electrode 3, when electric discharge is generated between the scanning electrode 2 and the address electrode 4, the electric discharges acts as a trigger, and thus, there is also generated electric discharge between the scanning electrode 2 and the sustaining electrode 3. As a result, similarly to electric discharge generated between the scanning electrode 2 and the address electrode 4, electric charges are accumulated on the dielectric layer 7A such that the voltage applied across the scanning electrode 2 and the sustaining electrode 3 is cancelled.

Then, a sustaining discharge pulse defined as a pulse voltage having the same polarity as that of the wall voltage is applied across the scanning electrode 2 and the sustaining electrode 3. Since the wall voltage is added as an effective voltage to the sustaining discharge pulse, even if a voltage amplitude of the sustaining discharge pulse is lower than a threshold voltage, the voltage amplitude of the sustaining discharge pulse exceeds the threshold voltage to thereby cause electric discharge.

Accordingly, it is possible to continue generation of electric discharges by keeping the sustaining discharge pulse applied across the scanning electrode 2 and the sustaining electrode 3. This function is the above-mentioned memory function.

Hereinbelow is explained a conventional method of driving a memory operation type and AC type plasma display panel.

FIG. 3 illustrates waveforms of voltages to be applied to electrodes in a conventional method of driving a plasma display panel.

The method explained hereinbelow is suggested in Japanese Patent Application Publication No. 2001-272948.

A voltage having such a waveform as illustrated is applied to each of the scanning electrodes, and further, to each of the address electrodes 4. A voltage having a common waveform is applied to the sustaining electrodes 3.

In FIG. 3, Y(i) indicates a waveform of a voltage to be applied to the scanning electrode 2 to be driven in an i-th order, X indicates a waveform of a voltage to be applied to the sustaining electrode 3, and (j) indicates a waveform of a voltage to be applied to the address electrode 4 to be driven in a j-th order.

As illustrated in FIG. 3, a drive cycle is comprised of an initialization period in which a display cell is initialized in order to make it easy to generate electric discharges, a scanning period in which a display cell or display cells to be turned on is(are) selected among a plurality of display cells, and a sustaining period in which a display cell or display cells selected in the scanning period is(are) turned on, that is, is(are) caused to emit a light therefrom.

In the initialization period, a sustaining-discharge eliminating pulse P1 is applied to all of the scanning electrodes 2 to generate charge-eliminating electric discharges to eliminate wall charges accumulated due to previous sustaining-discharge pulses P6.

Herein, the term “eliminate” should not be limited to elimination of all of wall charges, but should be interpreted as including reduction in wall charges for smoothly generating subsequent preliminary discharges, data-writing discharges and sustaining discharges.

Each of a preliminary discharge pulse P2 and a preliminary-discharge eliminating pulse P3 has an inclined waveform in which a voltage increases with the lapse of time. Electric discharges generated due to the preliminary discharge pulse P2 and the preliminary-discharge eliminating pulse P3 are weak electric discharges which could expand only in the vicinity of a discharge gap.

Since preliminary electric discharges and electric discharges for eliminating preliminary electric discharges are generated independently of images, lights emitted due to those electric discharges are observed as a background brightness. Hence, if the lights have a high intensity, contrast of images is degraded, and accordingly, image quality is reduced.

In the scanning period in which electric discharge is generated for selecting a display cell to be turned on, a scanning pulse P4 is successively applied to each of the scanning electrodes 2 at different timings, and an address pulse P5 is applied to the address electrode 4 in accordance with display data at the same timing as a timing at which the scanning pulse P4 is applied to the scanning electrodes 2.

In a display cell or display cells in which the address pulse P5 is applied to the address electrode 4, electric discharge is generated between the scanning electrode 2 and the address electrode 4, and this electric discharge induces another electric discharge between the scanning electrode 2 and the sustaining electrode 3.

The generation of the electric discharges for selection results in accumulation of positive electric charges on the dielectric layer 7A above the scanning electrodes 2, accumulation of negative electric charges on the dielectric layer 7A above the sustaining electrodes 3, and accumulation of negative electric charges on the dielectric layer 7B above the address electrodes 4.

A pulse width of the scanning pulse P4 is designed to be greater than a discharge-delay time in the electric discharges for selection. If the discharge-delay time is greater than a pulse width of the scanning pulse P4, there might not be generated the electric discharges for selection, causing wrong selection of a display cell, with the result of degradation in image quality.

In the sustaining period, surface electric discharge is generated between the scanning electrode 2 and the sustaining electrode 3, if a voltage due to electric charges having been accumulated on the dielectric layer 7A by the electric discharges for selection generated in the scanning period is added to a sustaining voltage.

A sustaining voltage is set equal to a voltage not beyond a threshold voltage at which surface electric discharge is generated, if the electric discharges for selection are not generated in the scanning period, and hence, wall electric charges are not accumulated on the dielectric layer 7A.

Accordingly, sustaining electric discharges are generated only in display cells having been selected in the scanning period.

The first sustaining electric discharge causes accumulation of negative electric charges on the dielectric layer 7A above the scanning electrodes 2, and accumulation of positive electric charges on the dielectric layer 7A above the sustaining electrodes 3.

Since the second sustaining-discharge pulse P6 has a voltage having a polarity opposite to a polarity of a voltage of the first sustaining-discharge pulse P6, a voltage caused by electric charges accumulated on the dielectric layer 7A is added to the voltage of the second sustaining-discharge pulse P6, there is generated second electric discharge.

Hereinafter, sustaining electric discharges are generated in the same way. If there is not generated surface electric discharge by the first sustaining-discharge pulse P6, there will not be generated surface electric discharges by subsequent sustaining-discharge pulse P6.

A sum of the above-mentioned initialization period, scanning period and sustaining period is called a sub-field.

In order to display images with a plurality of gray scales, a field defined as a period for displaying one scene is comprised of a plurality of sub-fields, and a number of the sustaining-discharge pulses P6 is set different in each of sub-fields.

Assuming that a field is divided into N sub-fields, and a brightness ratio of each of the sub-fields is set equal to 2⁰ to 2^{(N-1)}, it would be possible to display images with 2^{N} gray scales by selecting sub-fields to be displayed in a field and combining the selected sub-fields with one another.

For instance, if a field is divided into eight sub-fields, since the eighth power of two (2) makes 256 (2⁸=256), it would be possible to display images with 256 gray scales by carrying out on/off control to each of the sub-fields.

A conventional method of driving a plasma display panel is accompanied with a problem that discharge-delay time is greater at a later time in the scanning period.

The reason is explained hereinbelow.

In a discharge space, priming particles such as electrically charged particles and metastables are supplied by preliminary electric discharges and electric discharges for eliminating preliminary electric discharges, Since a lot of priming particles exist in a former half of the scanning period immediately after preliminary electric discharges have been eliminated, there is readily generated electric discharge, and hence, a discharge-delay time in the electric discharges for selection is quite small.

However, since a number of the priming particles decreases with the lapse of time, a discharge-delay time becomes greater at a later time in the scanning period.

FIG. 4 is a graph showing a relation between an order of scanning and a discharge-delay time.

As illustrated in FIG. 4, comparing beginning of the scanning period to ending of the scanning period, a discharge-delay time at the ending of the scanning period is about twice greater than a discharge-delay time at the beginning of the scanning period.

The scanning pulse P4 has to have a pulse width greater than a maximum of a discharge-delay time. A maximum of a discharge-delay time is determined at the final scanning. Hence, even if a discharge-delay time is relatively small at the beginning of the scanning period, the discharge-delay time would become greater, because a width of the scanning pulse P4 is determined at the ending of the scanning period.

Furthermore, a conventional method of driving a plasma display panel is accompanied with a problem that a discharge-delay time varies after a long-term operation of the plasma display panel.

The reason is as follows.

The protection layer 9 formed on the front substrate 1A, exposed to a discharge space, is degraded to some degree by bombardment with ions of discharge gas, generated due to electric discharges.

The protection layer 9 has a function of emitting electrons. Hence, due to a long-term operation, the protection layer 9 would have a varied surface and varied probability of emitting secondary electrons.

As a result, a discharge-delay time becomes greater after a long-term operation of the protection layer 9 than in initial operation of the protection layer 9.

Increase in a discharge-delay time causes degradation in images due to defectiveness in light emission, and lacking in long-term reliability.

In order to solve the above-mentioned problem, there has been suggested Japanese Patent Application Publication No. 2002-297091, for instance.

The Publication suggests a method of driving a plasma display panel including a plurality of pairs of first and second electrodes extending in parallel with each other, and a plurality of third electrodes three-dimensionally crossing the first and second electrodes. Display cells are formed at intersections of the first or second electrodes and the third electrodes. In a data-writing period, a scanning pulse is successively applied to the first electrodes, and a data pulse is selectively applied to the third electrodes, to thereby generate data-writing electric discharges in the selected display cells for writing data into the selected display cells. In a sustaining period subsequent to the data-writing period, the display cells into which data was written are caused to emit a light therefrom. When a scanning pulse is applied to the first electrodes in display cells to which data is to be written or display cells disposed adjacent to the firstly mentioned display cells in the data-writing period, there is generated preliminary electric discharge smaller than the electric discharge for writing data into the selected display cells.

In the method suggested in the above-identified Publication, preliminary electric discharge smaller than electric discharges for writing data into selected display cells are generated in the display cells in which data is to be written or display cells disposed therearound in a data-writing period while a scanning pulse is being scanned to the first electrodes. Hence, even if a pulse width of the scanning pulses and the data pulses are designed short, there does not occur defectiveness of writing data into a selected display cell, ensuring data can be surely written into a selected display cell. That is, it is possible to shorten a discharge-delay time.

In the method suggested in the above-identified Publication, a voltage having a pulse-shaped waveform is applied to the electrodes in order to generate preliminary electric discharge. In other words, preliminary electric discharge is generated in each of periods in which electric discharge is generated in selected display cells for a display line.

Hence, the method is accompanied with a problem that the discharge-delay time exists in the preliminary electric discharge, resulting in insufficient reduction in a discharge-delay time.

### SUMMARY OF THE INVENTION

It is an object of the present invention to provide a method of driving a plasma display panel which is capable of solving the above-mentioned problems in the conventional method.

It is further an object of the present invention to provide a plasma display panel and a plasma display unit including a plasma display panel, both of which are capable of solving the above-mentioned problems in the conventional method.

In one aspect of the present invention, there is provided a method of driving a plasma display panel including (a) a first electrode, (b) a second electrode extending in parallel with the first electrode to define a display line therebetween, and (c) a third electrode extending crossing with the first and second electrodes, display cells being defined at intersections of the first and second electrodes with the third electrode, display control being carried out to the display cells in dependence on whether there occurs electric discharge caused by applying a selection pulse to the first and third electrodes in a scanning period, the method including providing a fourth electrode which causes preliminary electric discharge together with one of the first, second and third electrodes, and keeping the preliminary electric discharge caused during a discharge period for at least two display lines in the scanning period.

In the method in accordance with the present invention, there is provided a fourth electrode. Preliminary electric discharge is generated between the fourth electrode and at least one of the first to third electrodes. The preliminary electric discharge is kept caused during a discharge period for at least two display lines in the scanning period. As a result, there are generated priming particles, and hence, it is possible to shorten a discharge-delay time in electric discharges for selection.

Furthermore, since a discharge-delay time is shortened by virtue of spatial electric charges, it would be possible to prevent a discharge-delay time in electric discharges for selection from varying even after a long-term operation of the protection film regardless of a condition of the protection film. Thus, it is possible to shorten a scanning period due to shortening a discharge-delay time, ensuring an increase in both a number of sub-fields and a number of sustaining-discharge pulses. Thus, it is possible to accomplish enhanced quality in images and long-term reliability to image quality.

It is preferable that the preliminary electric discharge is kept caused during the discharge period for at least a half of display lines in the scanning period.

It is preferable that the preliminary electric discharge is kept caused in a latter half of the scanning period.

It is preferable that the preliminary electric discharge is kept caused substantially entirely during the scanning period.

It is preferable that after the preliminary electric discharge has once started, the preliminary electric discharge is kept caused until the scanning period terminates.

It is preferable that the preliminary electric discharge is caused between the second and fourth electrodes.

It is preferable that the fourth electrode extends in parallel with the second electrode.

It is preferable that a pulse having a voltage varying with the lapse of time is applied to the fourth electrode in the scanning period.

It is preferable that the plasma display panel includes a plurality of the fourth electrodes, and wherein a pulse having a fixed voltage waveform is commonly applied to the fourth electrodes.

It is preferable that at least one of voltages to be applied to the fourth electrode is identical with a voltage to be applied to the first electrode, and is supplied from a voltage source which supplies voltages to the first electrode.

It is preferable that a preliminary discharge pulse for initializing the display cells is applied to the first electrode, and a pulse identical with the preliminary discharge pulse is applied to the fourth electrode at a timing identical with a timing at which the preliminary discharge pulse is applied to the first electrode.

It is preferable that a discharge-eliminating pulse for eliminating or adjusting electric charges of a display cell in which there occurred electric discharge contributing to a display brightness is applied to the first electrode, and a pulse identical with the discharge-eliminating pulse is applied to the fourth electrode at a timing identical with a timing at which the discharge-eliminating pulse is applied to the first electrode.

It is preferable that a preliminary discharge pulse for initializing the display cells is applied to the first electrode, and a voltage to which the pulse applied to the fourth electrode finally reaches is identical with a voltage to which a preliminary discharge-eliminating pulse to be applied to the first electrode after the preliminary discharge pulse was applied to the first electrode finally reaches.

It is preferable that a voltage to be applied to the fourth electrode in a period in which there is caused electric discharge for contributing to a display brightness is identical with a voltage of the second electrode in the same period.

It is preferable that electric discharge is caused between the third and fourth electrodes after the preliminary discharge pulse is applied to the first electrode, but before the preliminary discharge-eliminating pulse is applied to the first electrode. By generating the electric discharge, it is possible to adjust an amount of wall electric charges, ensuring stable operation of the plasma display panel.

It is preferable that a voltage to be applied to the fourth electrode after the preliminary discharge pulse is applied to the first electrode, but before the preliminary discharge-eliminating pulse is applied to the first electrode has a waveform identical with a waveform of the preliminary discharge-eliminating pulse to be applied to the first electrode.

In another aspect of the present invention, there is provided a plasma display panel including (a) a first electrode, (b) a second electrode extending in parallel with the first electrode to define a display line therebetween, (c) a third electrode extending crossing with the first and second electrodes, and (d) a fourth electrode which causes preliminary electric discharge together with one of the first, second and third electrodes, wherein display cells are defined at intersections of the first and second electrodes with the third electrode, display control is carried out to the display cells in dependence on whether there occurs electric discharge caused by applying a selection pulse to the first and third electrodes in a scanning period, and the preliminary electric discharge is kept caused during a discharge period for at least two display lines in the scanning period.

For instance, the second electrode is comprised of a first area and a second area, in which case, electric discharge being caused between the first area and the first electrode, and electric discharge being caused between the second area and the fourth electrode.

By comprising the second electrode of the first and second areas, a space in which electric discharge is to be generated between the first and second electrodes may be disposed independently of a space in which electric discharge is to be generated between the fourth and second electrodes, preventing the electric discharges from interfering with each other.

It is preferable that the first and second areas are separated by a slit from each other such that electric discharge between the first area and the first electrode is caused independently of electric discharge caused between the second area and the fourth electrode.

The plasma display panel may further include a partition wall extending in a row direction to separate display cells located adjacent to each other from each other, wherein the second electrode extends crossing the partition wall, a portion of the second electrode located at one side about the partition wall defines the first area, and a portion of the second electrode located at the other side about the partition wall defines the second area.

It is preferable that two partition walls extending in a row direction and disposed adjacent to each other define a first discharge space in which sustaining discharge is caused and a second discharge space in which preliminary discharge is caused. This arrangement makes it possible to prevent electric discharge contributing to a display brightness, generated at the first electrode, from expanding to the fourth electrode.

It is preferable that the fourth electrode is arranged every other display line. This arrangement makes it possible to increase a gap between the first, second and fourth electrodes, preventing reliability to electrode terminals from lowering.

It is preferable that two first electrodes and two second electrodes are alternately arranged.

The plasma display panel may further include a partition wall extending in a column direction to separate display cells located adjacent to each other from each other, wherein a portion of the third electrode facing the fourth electrode is spaced away from the fourth electrode through the partition wall. This arrangement makes it possible not to generate electric discharges between the fourth and the third electrodes, preventing deterioration in a discharge-delay time, wrong selection of a display cell, and unstable provision of priming particles.

In still another aspect of the present invention, there is provided a plasma display unit including the above-mentioned plasma display panel, and a driver circuit for driving the plasma display panel.

The plasma display unit provides the same advantages as those provided by the plasma display panel in accordance with the present invention.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is an exploded perspective view of the conventional plasma display panel.

FIG. 2 is a plan view of the conventional plasma display panel viewed through a display screen thereof.

FIG. 3 illustrates waveforms of voltages to be applied to electrodes in the conventional method of driving a plasma display panel.

FIG. 4 is a graph showing a relation between an order of scanning and a discharge-delay time in the conventional plasma display panel.

FIG. 5 is a plan view illustrating two display cells disposed adjacent to each other in a column direction of a plasma display panel in accordance with the first embodiment.

FIG. 6 illustrates waveforms of voltages to be applied to the electrodes in the plasma display panel in accordance with the first embodiment.

FIG. 7 illustrates waveforms of voltages to be applied to electrodes of a plasma display panel in the method in accordance with the second embodiment.

FIG. 8 illustrates a profile of wall charges found when sustaining electric discharge generated at the scanning electrode expands to the preliminary electrode.

FIG. 9 is a plan view illustrating two display cells disposed adjacent to each other in a column direction in a plasma display panel in accordance with the third embodiment.

FIG. 10 is a plan view illustrating two display cells disposed adjacent to each other in a column direction in a plasma display panel in accordance with the fourth embodiment.

FIG. 11 is a plan view illustrating two display cells disposed adjacent to each other in a column direction in a plasma display panel in accordance with the fifth embodiment.

FIG. 12 is a plan view illustrating two display cells disposed adjacent to each other in a column direction in a plasma display panel in accordance with the sixth embodiment.

FIG. 13A illustrates arrangement of panel terminals of the scanning electrodes in the conventional plasma display panel.

FIG. 13B illustrates arrangement of panel terminals of the scanning electrodes in the plasma display panel in accordance with the first embodiment.

FIG. 13C illustrates arrangement of panel terminals of the scanning electrodes 2 in the plasma display panel in accordance with the sixth embodiment.

FIG. 14 is a plan view illustrating two display cells disposed adjacent to each other in a column direction in a plasma display panel in accordance with the seventh embodiment.

FIG. 15 illustrates waveforms of voltages to be applied to electrodes in a plasma display panel in accordance with the eighth embodiment.

FIG. 16 illustrates waveforms of voltages to be applied to electrodes in a plasma display panel in accordance with the ninth embodiment.

FIG. 17 illustrates waveforms of voltages to be applied to electrodes in a plasma display panel in accordance with the tenth embodiment.

FIG. 18 is a block diagram of a plasma display unit including the plasma display panel in accordance with any one of the above-mentioned first to tenth embodiments.

### DESCRIPTION OF THE PREFERRED EMBODIMENTS

Preferred embodiments in accordance with the present invention will be explained hereinbelow with reference to drawings.

[First Embodiment]

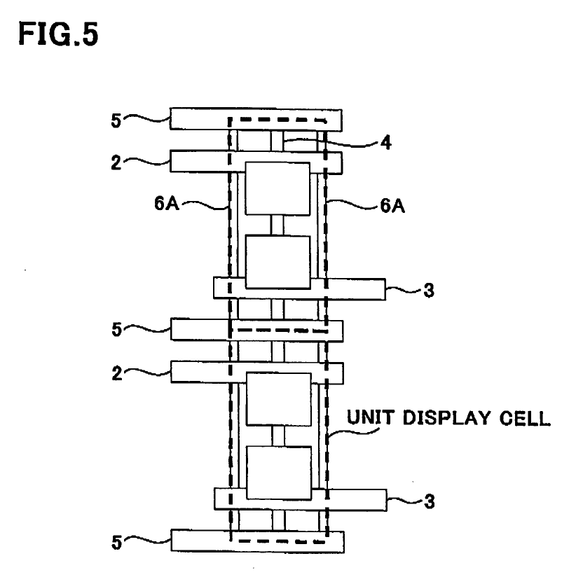

FIG. 5 is a plan view illustrating two display cells disposed adjacent to each other in a column direction of a plasma display panel in accordance with the first embodiment.

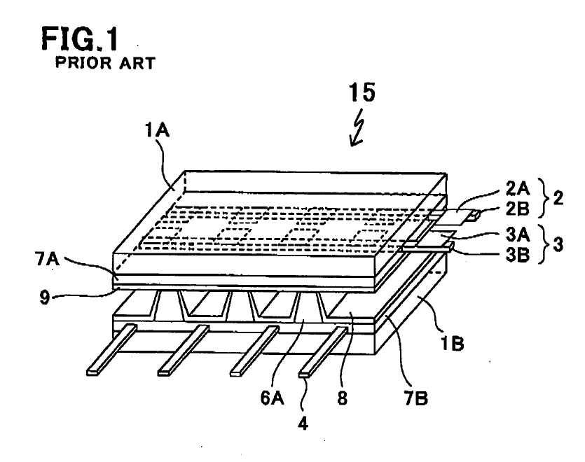

The plasma display panel in accordance with the first embodiment has the same structure as that of the conventional plasma display panel illustrated in FIG. 1 except a structure of a display cell.

As illustrated in FIG. 5, the structure of a display cell in the plasma display panel in accordance with the first embodiment is structurally different from a display cell in the conventional plasma display cell only in that a preliminary electrode 5 extends between the scanning electrode 2 and the sustaining electrode 3 in parallel with the scanning electrode 2 and the sustaining electrode 3.

Specifically, the plasma display panel in accordance with the first embodiment has the structure as follows.

The plasma display panel in accordance with the first embodiment is comprised of an electrically insulating front substrate 1A, and an electrically insulating rear substrate 1B facing the front substrate 1A.

The front substrate 1A is formed on a surface thereof facing the rear substrate 1B with a plurality of scanning electrodes 2 and a plurality of sustaining electrodes 3 spaced away from each other by a certain distance and extending in parallel with each other.

The front substrate 1A is formed on a surface thereof facing the rear substrate 1B further with a plurality of preliminary electrodes 5 extending between and in parallel with the scanning electrodes 2 and the sustaining electrodes 3.

Each of the scanning electrode 2 and the common electrode 3 is comprised of a bus electrode 2B, 3B providing electrical conductivity, and a primary discharge electrode 2A, 8A formed on the bus electrode 3A, 3B and causing electric discharge. The primary discharge electrode 2A, 3A is composed of transparent material such as ITO (IndiumrTin Oxide) or SnO₂ for preventing reduction in light-transmittance.

A dielectric layer 7A is formed on the front substrate 1A covering the scanning electrode 2, the sustaining electrode 3 and the preliminary electrodes 5 therewith. The dielectric layer 7A is covered with a protection layer 9 for protecting the dielectric layer 7A from electric discharges.

The protection layer 9 further has a function of emitting electrons when ions generated by electric discharges bombard to the protection layer 9, for making it easy to cause electric discharges.

In light of the above-mentioned two purposes, the protection layer 9 is composed of magnesium oxide (MgO), for instance. Electrons emitted when ions bombard to the protection layer 9 are called secondary electrons.

The rear substrate 1B is formed on a surface thereof facing the front substrate 1A with a plurality of address electrodes 4 extending in a direction perpendicular to a direction in which the scanning electrode 2 and the sustaining electrode 3 extend. The address electrodes 4 are equally spaced away from one another, and extend in parallel with one another.

A dielectric layer 7B is formed on the rear substrate 1B, covering the address electrodes 4 therewith. On the dielectric layer 7B is formed a plurality of partition walls 6A extending in parallel with the address electrodes 4. The partition walls 6A define a discharge space between the first and second substrates 1A and 1B, and the partition walls 6A located adjacent to each other define a display cell therebetween.

Fluorescent material 8 is coated on sidewalls of the partition walls 6A and an exposed surface of the dielectric layer 7B. The fluorescent material 8 converts ultra-violet rays generated by discharges, into visible lights. For instance, red, green and blue (RGB) fluorescent materials are coated every three cells, ensuring displaying color images.

Discharge gas spaces sandwiched between the front and rear substrates 1A and 1B and further between adjacent partition walls 6A are filled with discharge gas comprised of helium, neon or xenon alone or in combination, for instance.

A display cell in the first embodiment is defined by an area surrounded by the preliminary electrodes 5 disposed adjacent to each other and the partition walls 6A disposed adjacent to each other, as illustrated in FIG. 5.

As illustrated in FIG. 5, the scanning electrode 2 and the sustaining electrode 3 extend in a row direction in parallel with each other.

A gap formed between the scanning electrode 2 and the sustaining electrode 3 is called a discharge gap. Surface electric discharges are generated in the discharge gap between the scanning electrode 2 and the sustaining electrode 3.

Hereinbelow is explained a probability at which electric discharge is generated.

In order to generate electric discharge between electrodes in a display cell, it is necessary to apply a voltage beyond a threshold voltage across the electrodes.

It takes some time after a voltage was applied across the electrodes, until electric discharge is actually generated. Such time is called discharge-delay time.

Discharge-delay time is determined as probable time in view of various parameters of a plasma display panel. An important parameter is a density of electrically charges particles and metastables in a discharge space. Such electrically charges particles and metastables are called priming particles. A greater number of priming particles would present a higher discharge probability.

Hereinbelow is explained discharge operation to be carried out in a selected display cell.

Electric discharge is generated by applying a pulse voltage which is beyond a threshold voltage, across the scanning electrode 2 and the address electrode 4 in each of display cells. Then, positive and negative electric charges are attracted to surfaces of the dielectric layers 7A and 7B in dependence on polarity of the pulse voltage, and thus, positive and negative electric charges are accumulated on the dielectric layers 7A and 7B.

A wall voltage defined as an equivalent internal voltage caused by accumulation of electric charges has a polarity opposite to that of the pulse voltage. Accordingly, as electric discharge grows, an effective voltage lowers in a display cell. Thus, even if the pulse voltage is kept constant, it would not be possible to keep generating electric discharges, resulting in termination of electric discharges.

If a voltage beyond a predetermined level is applied across the scanning electrode 2 and the sustaining electrode 3, when electric discharge is generated between the scanning electrode 2 and the address electrode 4, the electric discharges acts as a trigger, and thus, there is also generated electric discharge between the scanning electrode 2 and the sustaining electrode 3. As a result, similarly to electric discharge generated between the scanning electrode 2 and the address electrode 4, electric charges are accumulated on the dielectric layer 7A such that the voltage applied across the scanning electrode 2 and the sustaining electrode 3 is cancelled.

Then, a sustaining discharge pulse defined as a pulse voltage having the same polarity as that of the wall voltage is applied across the scanning electrode 2 and the sustaining electrode 3. Since the wall voltage is added as an effective voltage to the sustaining discharge pulse, even if a voltage amplitude of the sustaining discharge pulse is lower than a threshold voltage, the voltage amplitude of the sustaining discharge pulse exceeds the threshold voltage to thereby cause electric discharge.

Accordingly, it is possible to continue generation of electric discharges by keeping the sustaining discharge pulse applied across the scanning electrode 2 and the sustaining electrode 3. This function is the above-mentioned memory function.

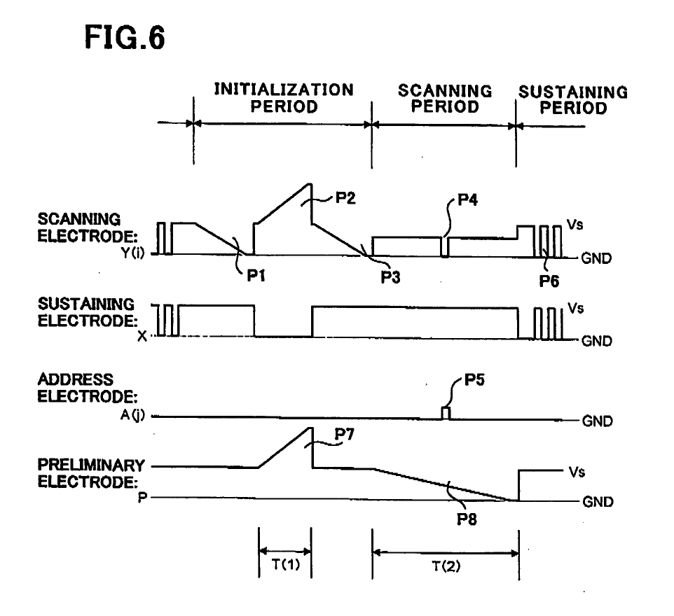

FIG. 6 illustrates waveforms of voltages to be applied to the electrodes in the plasma display panel in accordance with the first embodiment.

A voltage having such a waveform as illustrated in FIG. 6 is applied to each of the scanning electrodes 2, and further, to each of the address electrodes 4.

A voltage having a common waveform is applied to the sustaining electrodes 3.

A voltage having a common waveform is applied to the preliminary electrodes 5.

In FIG. 6, Y(i) indicates a waveform of a voltage to be applied to the scanning electrode 2 to be driven in an i-th order, X indicates a waveform of a voltage to be applied to the sustaining electrode 3. A(j) indicates a waveform of a voltage to be applied to the address electrode 4 to be driven in a j-th order, and P indicates a waveform of a voltage to be applied to the preliminary electrode 5.

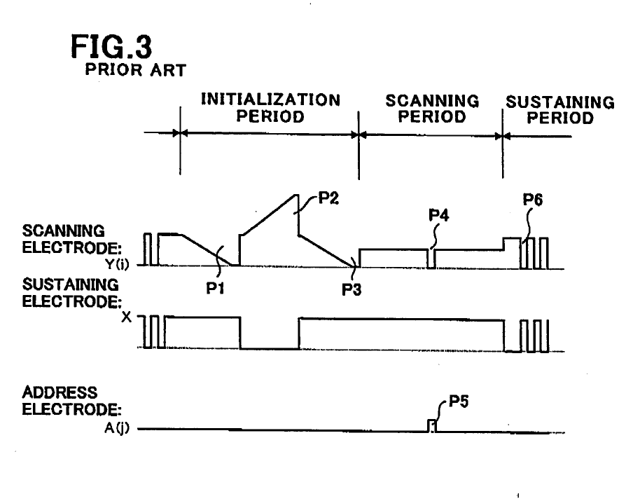

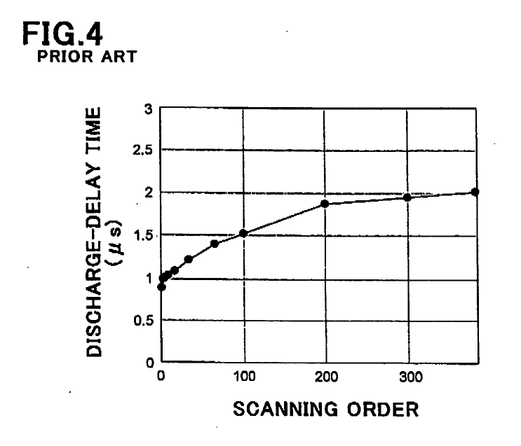

The waveforms of voltages to be applied to the scanning electrode 2, the sustaining electrode 3 and the address electrode 4 are identical with the waveforms in the conventional method, illustrated in FIG. 3.

As illustrated in FIG. 6, a drive cycle is comprised of an initialization period in which a display cell is initialized in order to make it easy to generate electric discharges, a scanning period in which a display cell or display cells to be turned on is(are) selected among a plurality of display cells, and a sustaining period in which a display cell or display cells selected in the scanning period is(are) turned on, that is, is(are) caused to emit a light therefrom.

In the initialization period, a sustaining-discharge eliminating pulse P1 is applied to all of the scanning electrodes 2 to generate charge-eliminating electric discharges to eliminate wall charges accumulated due to previous sustaining-discharge pulses P6.

Herein, the term “eliminate” should not be limited to elimination of all of wall charges, but should be interpreted as including reduction in wall charges for smoothly generating subsequent preliminary discharges and selection discharges.

Then, a preliminary discharge pulse P2 is applied to all of the scanning electrodes 2 to cause all of the display cells to mandatorily emit a light therefrom.

Then, a preliminary-discharge eliminating pulse P3 is applied to all of the scanning electrodes 2 to generate charge-eliminating electric discharges for eliminating wall charges having been accumulated due to the preliminary discharge pulse P2.

As mentioned earlier, the term “eliminate” should not be limited to elimination of all of wall charges, but should be interpreted as including reduction in wall charges for smoothly generating subsequent selection discharges and sustaining discharges.

The generation of the preliminary discharge and the elimination of the preliminary discharge make it easy to generate subsequent selection discharge.

Each of the preliminary discharge pulse P2 and the preliminary-discharge eliminating pulse P3 has an inclined waveform in which a voltage increases with the lapse of time. Electric discharges generated due to the preliminary discharge pulse P2 and the preliminary-discharge eliminating pulse P3 are weak electric discharges which could expand only in the vicinity of a discharge gap.

Since preliminary electric discharges and electric discharges for eliminating preliminary electric discharges are generated independently of images, lights emitted due to those electric discharges are observed as a background brightness. Hence, if the lights have a high intensity, contrast of images is degraded, and accordingly, image quality is reduced.

In the scanning period in which electric discharge is generated for selecting a display cell to be turned on, a scanning pulse P4 is successively applied to each of the scanning electrodes 2 at different timings, and an address pulse P5 is applied to the address electrode 4 in accordance with display data at the same timing as a timing at which the scanning pulse P4 is applied to the scanning electrodes 2.

In a display cell or display cells in which the address pulse P5 is applied to the address electrode 4, electric discharge is generated between the scanning electrode 2 and the address electrode 4, and this electric discharge induces another electric discharge between the scanning electrode 2 and the sustaining electrode 3.

That is, in the scanning period in which a display cell or display cells is(are) selected, a pulse for selection is applied to the scanning electrode 2 and the address electrode 4 independently in each of lines. Display control is carried out based on that presence or absence of electric discharge caused by the pulse for selection corresponds to whether a display cell is turned on or off.

The above-mentioned electric discharges subsequently generated are called electric discharges for selection.

The generation of the electric discharges for selection results in accumulation of positive electric charges on the dielectric layer 7A above the scanning electrodes 2, accumulation of negative electric charges on the dielectric layer 7A above the sustaining electrodes 3, and accumulation of negative electric charges on the dielectric layer 7B above the address electrodes 4.

A pulse width of the scanning pulse P4 is designed to be greater than a discharge-delay time in the electric discharges for selection. If the discharge-delay time is greater than a pulse width of the scanning pulse P4, there might not be generated the electric discharges for selection, causing wrong selection of a display cell, with the result of degradation in image quality.

In the sustaining period, surface electric discharge is generated between the scanning electrode 2 and the sustaining electrode 3, if a voltage due to electric charges having been accumulated on the dielectric layer 7A by the electric discharges for selection generated in the scanning period is added to a sustaining voltage.

A sustaining voltage is set not beyond a threshold voltage at which surface electric discharge is generated, if the electric discharges for selection are not generated in the scanning period, and hence, wall electric charges are not accumulated on the dielectric layer 7A.

Accordingly, sustaining electric discharges are generated only in display cells having been selected in the scanning period.

The first sustaining electric discharge causes accumulation of negative electric charges on the dielectric layer 7A above the scanning electrodes 2, and accumulation of positive electric charges on the dielectric layer 7A above the sustaining electrodes 3.

Since the second sustaining-discharge pulse P6 has a voltage having a polarity opposite to a polarity of a voltage of the first sustaining-discharge pulse P6, a voltage caused by electric charges accumulated on the dielectric layer 7A is added to the voltage of the second sustaining-discharge pulse P6, there is generated second electric discharge.

Hereinafter, sustaining electric discharges are generated in the same way.

If there is not generated surface electric discharge by the first sustaining-discharge pulse P6, there will not be generated surface electric discharges by subsequent sustaining-discharge pulse P6.

A total of the above-mentioned initialization period, scanning period and sustaining period is called a sub-field.

In order to display images with a plurality of gray scales, a field defined as a period for displaying one scene is comprised of a plurality of sub-fields, and a number of the sustaining-discharge pulses P6 to be applied in the sub-fields is set different in each of sub-fields.

Assuming that a field is divided into N sub-fields, and a brightness ratio of each of the sub-fields is set equal to 2⁰ to 2^{(N-1)}, it would be possible to display images with 2^{N} gray scales by selecting sub-fields to be displayed in a field and combining the selected sub-fields with one another.

For instance, if a field is divided into eight sub-fields, since the eighth power of two (2) makes 256 (2⁸=256), it would be possible to display images with 256 gray scales by carrying out on/off control to each of the sub-fields.

In the first embodiment, as illustrated in FIG. 6, a preliminary-discharge pulse P7 having the same waveform as that of the preliminary-discharge pulse P2 applied to the scanning electrode 2 is applied to the preliminary electrode 5 at the same timing as a timing at which the preliminary-discharge pulse P2 is applied to the scanning electrode 2.

That is, the preliminary-discharge pulse P7 identical with the preliminary-discharge pulse P2 is applied to the preliminary electrode 5 in order to initialize a display cell.

After the initialization period, a supplementary discharge pulse P8 having an inclined waveform in which a voltage gradually varies with the lapse of time is applied to the preliminary electrode 5 during the scanning period.

A voltage applied to the preliminary electrode 5 is fixed equal to a sustaining voltage Vs except during the preliminary discharge pulse P7 and the supplementary discharge pulse P8 are being applied to the preliminary electrode 5.

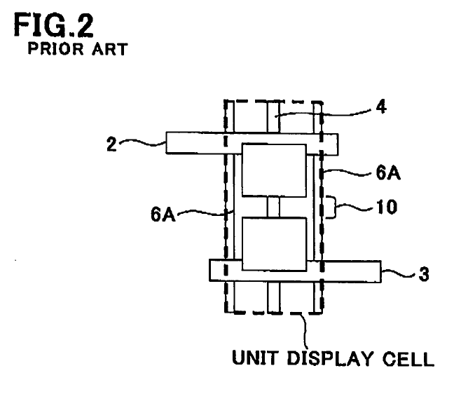

In comparison with the conventional plasma display panel and a method of driving the same, illustrated in FIGS. 2 and 3, the plasma display panel in accordance with the first embodiment and a method of driving the same make it possible to almost uniformize a discharge-delay time of electric discharge for selection in the scanning period regardless of a scanning order, and shorten a discharge-delay time.

Furthermore, it is also possible to keep a discharge-delay time of electric discharge for selection almost constant regardless of a time during which the plasma display panel operates.

This is because electric discharge is kept generated between the sustaining electrode 3 and the preliminary electrode 5 after the preliminary electric discharge started, until the scanning period ends, and hence, priming particles always exist in a discharge space, facilitating generation of electric discharges.

The reason is as follows.

Electric discharges are generated among the scanning electrode 2, the sustaining electrode 3 and the address electrode 4 in the same way as the conventional method. The plasma display panel in accordance with the first embodiment is different from the conventional plasma display panel in electric discharges generated between the preliminary electrode 5 and the scanning electrode 2, the sustaining electrode 3 or the address electrode 4.

A period in which electric discharges are generated between the preliminary electrode 5 and the scanning electrode 2, the sustaining electrode 3 or the address electrode 4 is divided into two periods T(1) and T(2) illustrated in FIG. 6.

In the period T(1), electric discharge is generated between the preliminary electrode 5 and the sustaining electrode 3. The electric discharge is identical with electric discharge generated between the scanning electrode and the sustaining electrode 3 in the initialization period, and accordingly, is weak electric discharge. During application of the preliminary discharge pulse P7 to the preliminary electrode 5, negative electric charges are accumulated on the preliminary electrode 5, and positive electric charges are accumulated on the sustaining electrode 5 at a side close to the preliminary electrode 5.

In the period T(2), wall charges having been formed in the period T(1) are eliminated. Since a voltage at the sustaining electrode 3 is fixed during the elimination of wall charges, weak electric discharge is kept generated during a voltage of the preliminary electrode 5 varies, similarly to the preliminary-discharge eliminating pulse P3.

After a voltage of the inclined waveform is below a predetermined voltage, electric discharge is generated as a voltage varies. The thus generated electric discharge is weak electric discharge which can expand only in the vicinity of a discharge gap. That is, a voltage is kept close to a voltage at which electric discharge is generated by virtue of balance between accumulation of wall charges caused by the electric discharge and an increase in a voltage across the electrodes, caused by the voltage having the inclined waveform. Thus, once electric discharge starts being generated, weak electric discharge is kept generated only in the vicinity of the discharge gap until application of a voltage having the inclined waveform terminates. In other words, after the supplementary electric discharge has once started, the supplementary electric discharge is kept generated substantially until the scanning period terminates.

The supplementary electric discharge generated between the preliminary electrode 5 and the sustaining electrode 3 induces generation of priming particles, which scatters into a discharge space.

Since the weak electric discharge is kept generated in all of the display cells until the scanning period terminates, priming particles are kept supplied into a discharge space during the scanning period.

Accordingly, a discharge-delay time in electric discharge for selection generated between the scanning electrode 2 and the address electrode 4 is small regardless of a scanning order.

Furthermore, since priming particles existing in a discharge space facilitate generation of electric discharge, it would be possible to prevent reduction in an electric-discharge probability, even if a surface condition of the protection film 9 varies after long-term operation of the plasma display panel, and hence, a likelihood of emission of secondary electrons varies.

In addition, if an electric-discharge probability is relatively high, a discharge-delay time does not vary so much, even if the electric-discharge probability lowers to some degree. Hence, it is possible to keep a discharge-delay time identical with an initial discharge-delay time even after long-term operation of the plasma display panel, preventing defectiveness in display images such as defectiveness in light emission.

In the beginning of the scanning period, the supplementary electric discharge is not generated until a voltage exceeds a threshold voltage at which electric discharge is generated between the preliminary electrode 5 and the sustaining electrode 3. However, priming particles having been generated due the preliminary electric discharge and the electric discharge for eliminating the preliminary electric discharge are residual without being eliminated. Since a discharge-delay time is shortened due to those priming particles, there is caused no problem, even if electric discharge is not generated between the preliminary electrode 5 and the sustaining electrode 3.

As having been explained so far, since a discharge-delay time of electric discharge for selection is kept almost constant regardless of a scanning order, and is shortened, it is possible to shorten a width of a scanning pulse, which enables to shorten a scanning period. As a result, it is also possible to increase a number of sub-fields and a number of sustaining-discharge pulses, ensuring enhancement in image quality.

It is also possible to enhance long-term reliability to a final product, that is, a plasma display panel.

Furthermore, since the preliminary discharge pulse P2 applied to the scanning electrode 2 and the preliminary discharge pulse P7 applied to the preliminary electrode 5 have a common voltage, and a voltage to which the preliminary-discharge eliminating pulse P3 finally reaches is identical with a voltage to which the preliminary discharge pulse P8 finally reaches, it is possible to produce those pulses from a common power-source, ensuring cost reduction.

Since one of the voltages to be applied to the preliminary electrode 5 is a voltage Vs also applied to the scanning electrode 2, it is possible to use a common power-source from which a voltage to be applied to the scanning electrode 2 and the preliminary electrode 5 is supplied. That is, since at least one of the voltages to be applied to the preliminary electrode 5 is equal to a voltage to be applied to the scanning electrode 2, it is possible to apply a voltage to the preliminary electrode 5 from a power-source from which a voltage is applied to the scanning electrode 2.

Furthermore, a voltage (GND) to which the sustaining-discharge eliminating pulse P9 applied to the preliminary electrode 5 in the scanning period finally reaches is equal to a voltage (GND) to which the preliminary-discharge eliminating pulse P3 applied to the scanning electrode 2 for adjusting an amount of wall charges after the preliminary discharge pulse P2 has been applied to the scanning electrode 2 finally reaches.

The first embodiment provides a method of driving a plasma display panel including (a) a first electrode, (b) a second electrode extending in parallel with the first electrode to define a display line therebetween, and (c) a third electrode extending crossing with the first and second electrodes, display cells being defined at intersections of the first and second electrodes with the third electrode, display control being carried out to the display cells in dependence on whether there occurs electric discharge caused by applying a selection pulse to the first and third electrodes in a scanning period, the method including providing a fourth electrode which causes preliminary electric discharge together with one of the first, second and third electrodes, and keeping the preliminary electric discharge caused during a discharge period for at least two display lines in the scanning period. By keeping the preliminary electric discharge generated, there are generated a lot of priming particles, shortening a discharge-delay time of electric charge for selection, Thus, it is possible to prevent a discharge-delay time of electric charge for selection from varying even after long-term operation of the plasma display panel regardless of a condition of the protection layer 9. The scanning period can be shortened by a discharge-delay time being shortened. As a result, it is possible to increase a number of sub-fields and a number of the sustaining-discharge pulses, ensuring high quality in displayed images and long-term reliability to image quality.

[Second Embodiment]

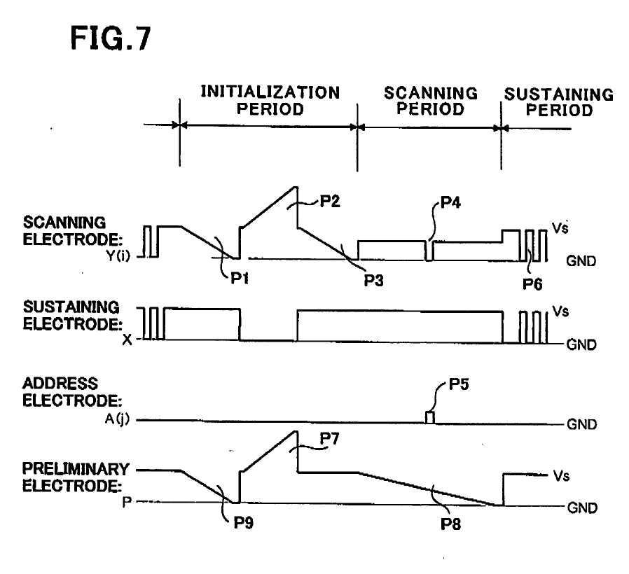

Hereinbelow is explained a method of driving a plasma display panel in accordance with the second embodiment, with reference to FIG. 7.

FIG. 7 illustrates waveforms of voltages to be applied to electrodes of a plasma display panel in the method in accordance with the second embodiment.

A plasma display panel in which the method in accordance with the second embodiment is carried out is structurally identical with the plasma display panel in accordance with the first embodiment, illustrated in FIG. 5.

The second embodiment is different from the first embodiment only in that a sustaining-discharge eliminating pulse P9 is applied to the preliminary electrode 5 before application of the preliminary discharge pulse P7 to the preliminary electrode 5, similarly to the scanning electrode 2.

Sustaining electric discharge is generated between the scanning electrode 2 and the sustaining electrode 3 for ensuring a desired brightness. The preliminary electrode 5 is not used for generating such sustaining electric discharge. However, the sustaining electric discharge generated in the scanning electrode 2 or the sustaining electrode 3 may expand to thereby form electric charges on the preliminary electrode 5.

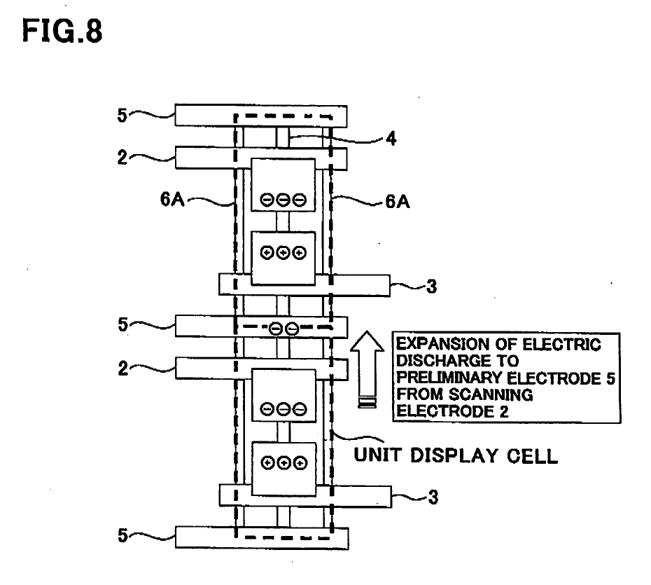

FIG. 8 illustrates a profile of wall charges found when sustaining electric discharge generated at the scanning electrode 2 expands to the preliminary electrode 5.

As illustrated in FIG. 8, the sustaining electric discharge generated immediately before application of the sustaining-discharge eliminating pulse P2 to the scanning electrode 2 causes negative wall charges to be accumulated on the scanning electrode 2 and positive wall charges to be accumulated on the sustaining electrode 3. If the sustaining electric discharge generated at the scanning electrode 2 expands to the preliminary electrode 5, negative wall charges are accumulated also on the preliminary electrode 5.

The negative wall charges accumulated on the preliminary electrode 5 reduces an effective voltage of the preliminary electrode 5 caused by the preliminary discharge pulse P7 applied to the preliminary electrode 5. Hence, a time at which electric discharge starts between the preliminary electrode 5 and the sustaining electrode 3 by the preliminary discharge pulse P7 is retarded.

Accordingly, the supplementary discharge pulse P8 can no longer supply priming particles in periods other than the beginning of the scanning period, resulting in that a discharge-delay time of the electric discharge for selection is no longer shortened.

Thus, the sustaining-discharge eliminating pulse P9 is applied to the preliminary electrode 5 similarly to the scanning electrode 2, to thereby generate electric discharge between the preliminary electrode 5 and the sustaining electrode 3. As a result, wall charges accumulated on the preliminary electrode 5 are reduced. This ensures that the preliminary discharge pulse P7 can stably operate, and further, the subsequent supplementary discharge pulse P8 can stable operate.

In accordance with the second embodiment, the sustaining-discharge eliminating pulse P1 for eliminating or adjusting electric charges of a display cell in which there was generated electric discharge contributing to a display brightness is applied to the scanning electrode, and a pulse identical with the sustaining-discharge eliminating pulse P1 is applied to the preliminary electrode 5 at a timing identical with a timing at which the sustaining-discharge eliminating pulse P1 is applied to the scanning electrode 2. Thus, it is possible to adjust an amount of wall charges accumulated on the preliminary electrode 5, by generating electric discharge between the preliminary electrode 5 and the sustaining electrode 2. This ensures that the preliminary discharge pulse P7 can stably operate, and further, the subsequent supplementary discharge pulse P8 can stable operate.

[Third Embodiment]

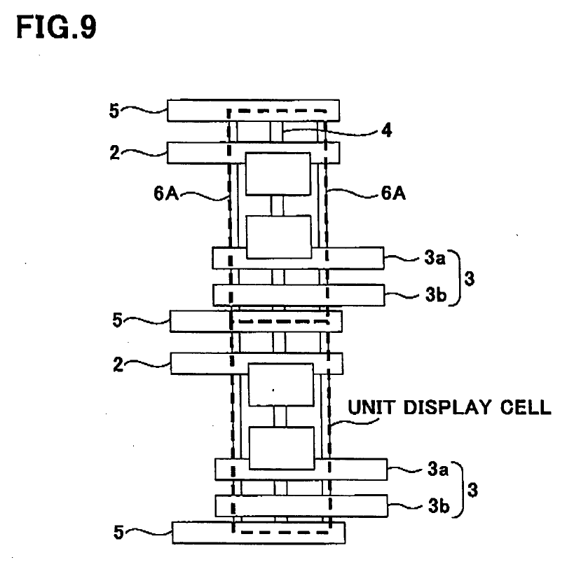

FIG. 9 is a plan view illustrating two display cells disposed adjacent to each other in a column direction in a plasma display panel in accordance with the third embodiment.

The plasma display panel in accordance with the third embodiment is driven in the same way as the plasma display panel in accordance with the first embodiment. Specifically, the plasma display panel in accordance with the third embodiment is driven through the pulses illustrated in FIG. 6.

The plasma display panel in accordance with the third embodiment is structurally different from the plasma display panel in accordance with the first embodiment in that the sustaining electrode 3 is comprised of a first area 3a and a second area 3b, as illustrated in FIG. 9.

The sustaining electrode 3 causes preliminary electric discharge together with the scanning electrode 2 and the preliminary electrode 5 therebetween, electric discharge for eliminating preliminary electric discharge together with the scanning electrode 2 therebetween, and supplementary electric discharge together with the preliminary electrode 5 therebetween. Namely, the sustaining electrode 3 causes electric discharges together with the electrodes disposed at opposite sides of the sustaining electrode 3.

Hence, the electric discharge generated between the scanning electrode 2 and the sustaining electrode 3 often interferes with the electric discharge generated between the preliminary electrode 5 and the sustaining electrode 3, in which case, the electric discharges are put into unstable condition.

In order to solve this problem, the sustaining electrode 3 in the third embodiment is designed to be comprised of the first area 3a which causes electric discharge together with the scanning electrode 2 therebetween, and the second area 3b which causes electric discharge together with the preliminary electrode 5 therebetween.

The first and second areas 3a and 3b are electrically connected to each other.

By comprising the sustaining electrode 3 of the first and second areas 3a and 3b, a discharge area formed between the scanning electrode 2 and the sustaining electrode 3 is independent from a discharge area formed between the preliminary electrode 5 and the sustaining electrode 3, making it possible to prevent the electric discharge generated between the scanning electrode 2 and the sustaining electrode 3 from interfering with the electric discharge generated between the preliminary electrode 5 and the sustaining electrode 3.

In the third embodiment, the first and second areas 3a and 3b are separated from each other through a slit formed therebetween.

Since the preliminary electrode 5 causes only weak electric discharge, it is not necessary for the preliminary electrode 5 to have a low resistance like a bus electrode. Hence, the preliminary electrode 5 may be composed of transparent material such as ITO.

In the plasma display panel in accordance with the third embodiment, the sustaining electrode 3 is comprised of the first area 3a and the second area 3b. The first area 3a causes electric discharge together with the scanning electrode 2 therebetween, and the second area 3b causes electric discharge together with the preliminary electrode 5 therebetween. Accordingly, a discharge area formed between the scanning electrode 2 and the sustaining electrode 3 is independent from a discharge area formed between the preliminary electrode 5 and the sustaining electrode 3, making it possible to prevent the electric discharge generated between the scanning electrode 2 and the sustaining electrode 3 from interfering with the electric discharge generated between the preliminary electrode 5 and the sustaining electrode 3.

[Fourth Embodiment]

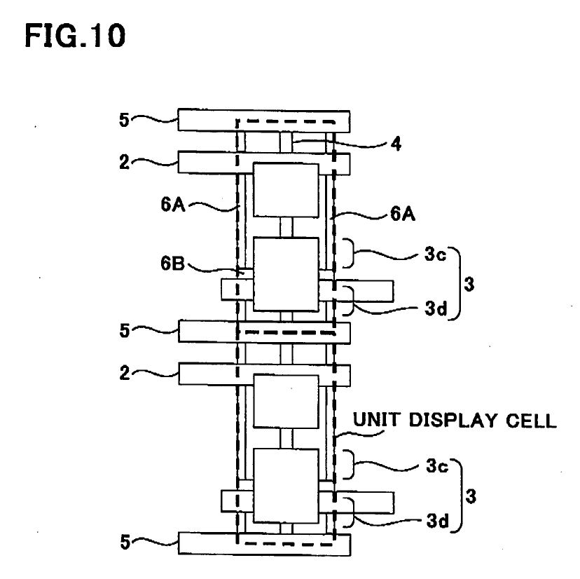

FIG. 10 is a plan view illustrating two display cells disposed adjacent to each other in a column direction in a plasma display panel in accordance with the fourth embodiment.

The plasma display panel in accordance with the fourth embodiment is driven in the same way as the plasma display panel in accordance with the first embodiment Specifically, the plasma display panel in accordance with the fourth embodiment is driven through the pulses illustrated in FIG. 6.

As illustrated in FIG. 10, the plasma display panel in accordance with the fourth embodiment is structurally different from the plasma display panel in accordance with the first embodiment in having a partition wall 6B extending in a row direction, as well as the partition wall 6A extending in a column direction. The sustaining electrode 3 overlaps the partition wall 6B, and crosses the partition wall 6B.

The sustaining electrode 3 in the fourth embodiment is comprised of a first area 3c which is disposed at one side about the partition wall 6B and causes electric discharge together with the scanning electrode 2 therebetween, and a second area 3d which is disposed at the other side about the partition wall 6B and causes electric discharge together with the preliminary electrode 5 therebetween.

Without the partition wall 6B, the sustaining electric discharge generated at the sustaining electrode 3 expands to the preliminary electrode 5 with the result of accumulation of wall charges on the preliminary electrode 5. This causes a time at which electric discharge caused by the preliminary discharge pulse P7 and the supplementary discharge pulse P8 starts to vary, and a discharge-delay time of the electric discharge for selection not to be shortened.

The plasma display panel in accordance with the fourth embodiment is designed to include the partition wall 6B to thereby physically suppress expansion of the sustaining electric discharge.

That is, since the first area 3a and the second area 3d are physically separated from each other by the partition wall 6B, electric discharge generated between the scanning electrode 2 and the first area 3c of the sustaining electrode 3 and electric discharge generated between the preliminary electrode 5 and the second area 3d of the sustaining electrode 3 do not interfere with each other, ensuring those electric discharges to be stably generated.

In the plasma display panel in accordance with the fourth embodiment, the rear substrate 1B is designed to include the partition wall 6B extending in a row direction to separate display cells located adjacent to each other from each other, and the sustaining electrode 3 extends crossing the partition wall 6B. A portion of the sustaining electrode 3 located at one side about the partition wall 6B defines the first area 3c, and a portion of the sustaining electrode 3 located at the other side about the partition wall 6B defines the second area 3d.

Thus, similarly to the third embodiment, a discharge area formed between the scanning electrode 2 and the sustaining electrode 3 is independent from a discharge area formed between the preliminary electrode 5 and the sustaining electrode 3, making it possible to prevent the electric discharge generated between the scanning electrode 2 and the sustaining electrode 3 from interfering with the electric discharge generated between the preliminary electrode 5 and the sustaining electrode 3.

[Fifth Embodiment]

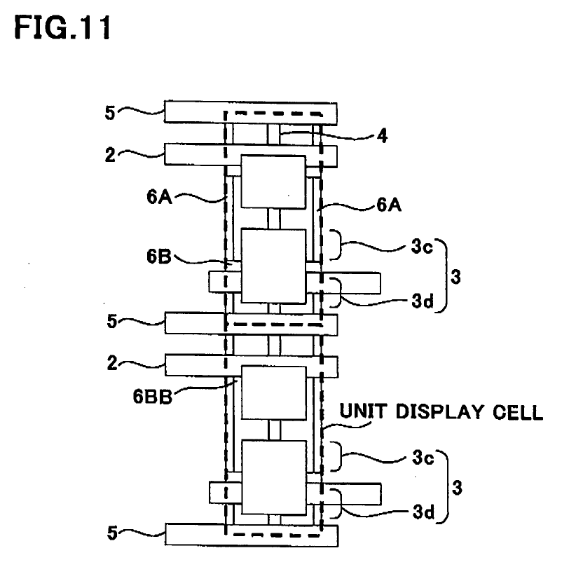

FIG. 11 is a plan view illustrating two display cells disposed adjacent to each other in a column direction in a plasma display panel in accordance with the fifth embodiment.

The plasma display panel in accordance with the fifth embodiment is driven in the same way as the plasma display panel in accordance with the first embodiment. Specifically, the plasma display panel in accordance with the fifth embodiment is driven through the pulses illustrated in FIG. 6.

The plasma display panel in accordance with the fifth embodiment is designed to include, in addition to the structure of the plasma display panel in accordance with the fourth embodiment, a second partition wall 6BB extending in a row direction to define an additional space other than a display cell.

Electric discharge is generated in the additional space between the preliminary electrode 5 and the sustaining electrode 3.

The additional space is defined by the partition walls 6B and 6BB both extending in a row direction. However, there exists a small gap between the front and rear substrates 1A and 1B due to fluctuation in a height of the partition walls 6B and 6BB. Such fluctuation in a height is caused when the partition walls 6B and 6BB are baked, for instance.

Priming particles generated in electric discharge generated between the preliminary electrode 5 and the second area 3d of the sustaining electrode 3 flow into a display cell in which electric discharge is being generated, through the small gap. As a result, a discharge-delay time of electric discharge for selection is shortened.

The two partition walls 6B and 6BB prevent expansion of sustaining electric discharge generated at the scanning electrode 2, into the preliminary electrode 5, resulting in that the preliminary discharge pulse P6 and supplementary discharge pulse P8 can stable operate.

Since a gap formed between the front and rear substrates 1A and 1B is quite small, a discharge-delay time is shortened in a less degree in the fifth embodiment than in the first embodiment. However, the plasma display panel in accordance with the fifth embodiment makes it possible to significantly suppress interference of the electric discharges with each other, ensuring stable operation of the plasma display panel.

In the plasma display panel in accordance with the fifth embodiment, the two partition walls 6B and 633B extending in a row direction and disposed adjacent to each other define a first discharge space in which the sustaining discharge is generated and a second discharge space in which the supplementary discharge is generated. Thus, it is possible to prevent the sustaining electric discharge generated at the scanning electrode 2 from expanding to the preliminary electrode 5, ensuring that the preliminary discharge pulse P6 and supplementary discharge pulse P8 can stable operate.

In the arrangement in which the two partition walls 6B and 6BB define a first discharge space in which the sustaining discharge is generated and a second discharge space in which the supplementary discharge is generated, an opaque layer may be formed to cover therewith a discharge space of the front substrate 1A, facing a discharge space in which the supplementary electric discharge is generated, such that the supplementary electric discharge cannot be seen by a viewer. The formation of such an opaque layer enhances a display contrast.

[Sixth Embodiment]

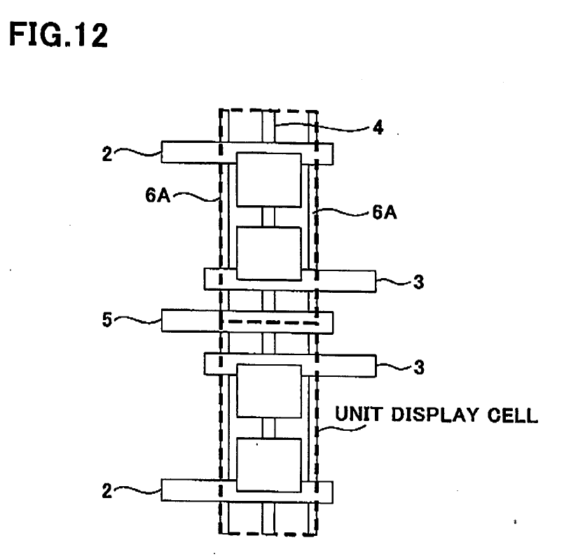

FIG. 12 is a plan view illustrating two display cells disposed adjacent to each other in a column direction in a plasma display panel in accordance with the sixth embodiment.

The plasma display panel in accordance with the sixth embodiment is driven in the same way as the plasma display panel in accordance with the first embodiment. Specifically, the plasma display panel in accordance with the sixth embodiment is driven through the pulses illustrated in FIG. 6.

The plasma display panel in accordance with the sixth embodiment is structurally different from the plasma display panel in accordance with the first embodiment in the arrangement of the scanning electrode 2 and the sustaining electrode 3.

Specifically, the scanning electrode 2 and the sustaining electrode 3 are alternately arranged in the plasma display panel in accordance with the first embodiment, as illustrated in FIG. 5, the two scanning electrodes 2 are arranged adjacent to each other, and the two sustaining electrodes 3 are arranged adjacent to each other in the plasma display panel in accordance with the sixth embodiment, as illustrated in FIG. 12. In other words, a pair of the scanning electrodes 2 and a pair of the sustaining electrodes 3 are alternately arranged.

The preliminary electrode 5 is arranged between the sustaining electrodes 3 disposed adjacent to each other. That is, the preliminary electrode 5 is arranged at every other display line.

Electric discharges are generated between the preliminary electrode 5 and the two sustaining electrodes 3 disposed sandwiching the preliminary electrode 5 therebetween. Priming particles generated in the electric discharges expand into display cells disposed sandwiching the preliminary electrode 5 therebetween. A discharge-delay time of electric discharge for selection is shortened in both of the display cells.

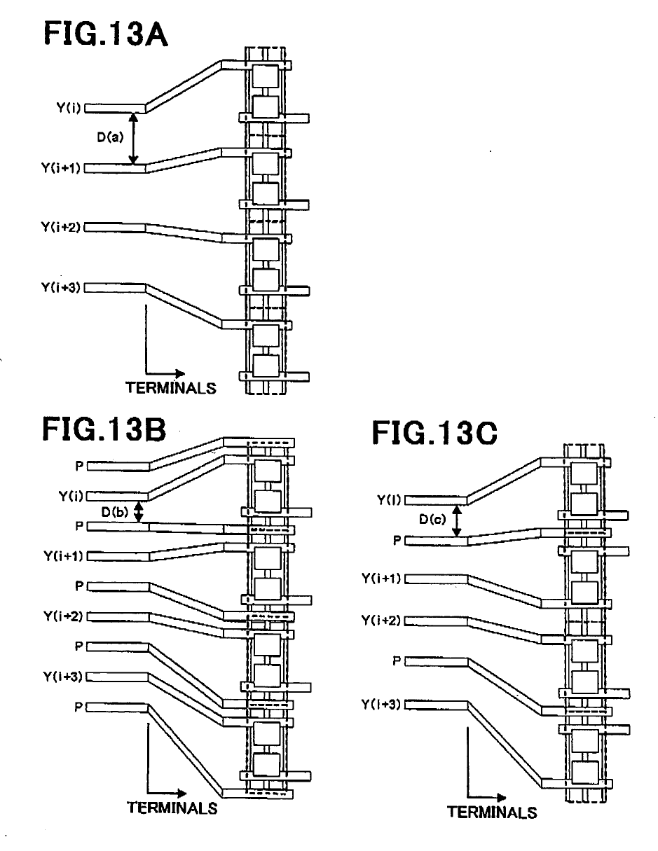

FIG. 13A illustrates arrangement of panel terminals of the scanning electrodes 2 in the conventional plasma display panel, FIG. 13B illustrates arrangement of panel terminals of the scanning electrodes 2 in the plasma display panel in accordance with the first embodiment, and FIG. 13C illustrates arrangement of panel terminals of the scanning electrodes 2 in the plasma display panel in accordance with the sixth embodiment.

In FIGS. 13A to 13C, Y(i) indicates an i-th scanning electrode 2, Y(i+1) indicates a (i+1)-th scanning electrode 2, that is, a scanning electrode 2 disposed adjacent to the i-th scanning electrode 2, Y(i+2) indicates a (i+2)-th scanning electrode 2, that is, a scanning electrode 2 disposed adjacent to the (i+1)-th scanning electrode 2, and Y(i+3) indicates a (i+3)-th scanning electrode 2, that is, a scanning electrode 2 disposed adjacent to the (i+2)-th scanning electrode 2.

As illustrated in FIG. 13B, since the plasma display panel in accordance with the first embodiment includes the preliminary electrodes 5 in the same number as that of the scanning electrodes 2, a distance D(b) between the scanning electrodes 2 at terminals thereof is smaller than a distance D(a) between the scanning electrodes 2 in the conventional plasma display panel (see FIG. 13A).

A small distance between the scanning electrodes 2 at terminals thereof causes problems of reduction in a breakdown voltage and generation of migration.

In contrast, since the preliminary electrodes 5 are arranged only between the sustaining electrodes 3 in the plasma display panel in accordance with the sixth embodiment, a number of the preliminary electrodes 5 in the sixth embodiment is just a half of a number of the preliminary electrodes 5 in the plasma display panel in accordance with the fist embodiment.

Thus, as illustrated in FIG. 13C, a distance D(c) between the scanning electrodes 2 at terminals thereof in the sixth embodiment is greater than the distance D(b) between the scanning electrodes 2 at terminals thereof in the first embodiment.

Thus, a total number of the scanning electrodes 2 and the sustaining electrodes 3 at terminals thereof can be reduced in comparison with the first embodiment, ensuring that a distance between the scanning electrodes 2 at terminals thereof can be made greater than that of the first embodiment. This enhances reliability to the terminals.

In the plasma display panel in accordance with the first embodiment, since the preliminary electrodes 5 are arranged at every other display line, it is possible to increase a distance between the electrodes at terminals thereof, enhancing reliability to the terminals.

[Seventh Embodiment]

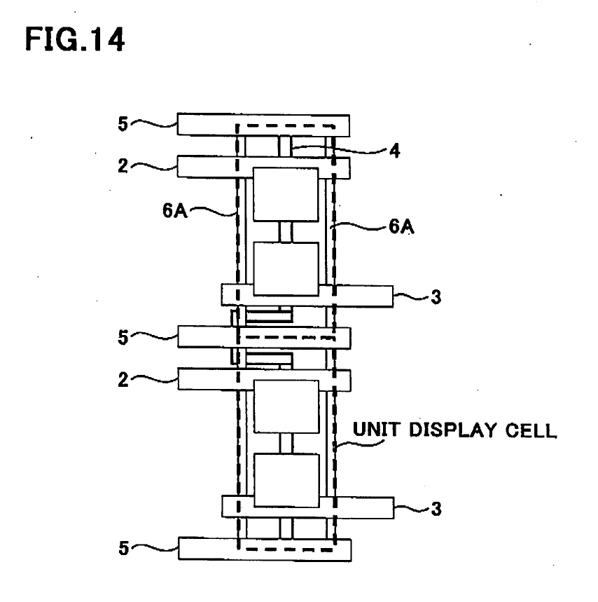

FIG. 14 is a plan view illustrating two display cells disposed adjacent to each other in a column direction in a plasma display panel in accordance with the seventh embodiment.

The plasma display panel in accordance with the seventh embodiment is driven in the same way as the plasma display panel in accordance with the first embodiment. Specifically, the plasma display panel in accordance with the seventh embodiment is driven through the pulses illustrated in FIG. 6.

The plasma display panel in accordance with the seventh embodiment is structurally different from the plasma display panel in accordance with the first embodiment in that the address electrode 4 has a portion crossing the preliminary electrode 5, disposed below the partition wall 6A.

Specifically, the rear substrate 1B includes the partition walls 6A each extending in a column direction to separate display cells disposed adjacent to each other in a row direction, from each other. The address electrode 4 has a portion crossing the preliminary electrode 5, spaced away from the preliminary electrode 5 with the partition wall 6A being sandwiched therebetween.

In accordance with the pulses illustrated in FIG. 6, weak electric discharge is generated between the preliminary electrode 5 and the sustaining electrode 3. When the weak electric discharge is generated, there may be generated also between the preliminary electrode 5 and the address electrode 4.

If the electric discharge generated between the preliminary electrode 5 and the address electrode 4 expands to a portion of the address electrode 4 crossing the scanning electrode 2, an amount of wall charges accumulated on the address electrode 4 may be varied.

If an amount of the wall charges is varied in a display cell in which electric discharge for selection is not yet generated, a voltage at which electric discharge for selection is generated would rise, resulting in that a discharge-delay time may be deteriorated.

If an amount of the wall charges is varied in a display cell in which electric discharge for selection has been already generated, a display cell may be wrongly selected, resulting in that images cannot be displayed correctly.

Furthermore, if there is generated the above-mentioned electric discharge between the preliminary electrode 5 and the address electrode 4, the weak electric discharge being generated between the preliminary electrode 5 and the sustaining electrode 3 may be made unstable, resulting in insufficient provision of priming particles.

In order to avoid the above-mentioned problems, it is necessary to prevent the electric discharge from being generated between the preliminary electrode 5 and the address electrode 4. In the plasma display panel in accordance with the seventh embodiment, the electric discharge to be generated between the preliminary electrode 5 and the address electrode 4 is prevented from being generated by arranging a portion of the address electrode 4 crossing the preliminary electrode 5, below the partition wall 6A.

In the plasma display panel in accordance with the seventh embodiment, the rear substrate 1B has the partition wall 6A extending in a column direction to separate display cells located adjacent to each other, from each other. A portion of the address electrode 4 facing the preliminary electrode 5 is spaced away from the preliminary electrode 5 with the partition wall 6A being sandwiched therebetween. Thus, it is possible to prevent generation of the electric discharge between the preliminary electrode 5 and the address electrode 4, preventing deterioration in a discharge-delay time, wrong selection of a display cell, and insufficient supply of priming particles.

[Eighth Embodiment]

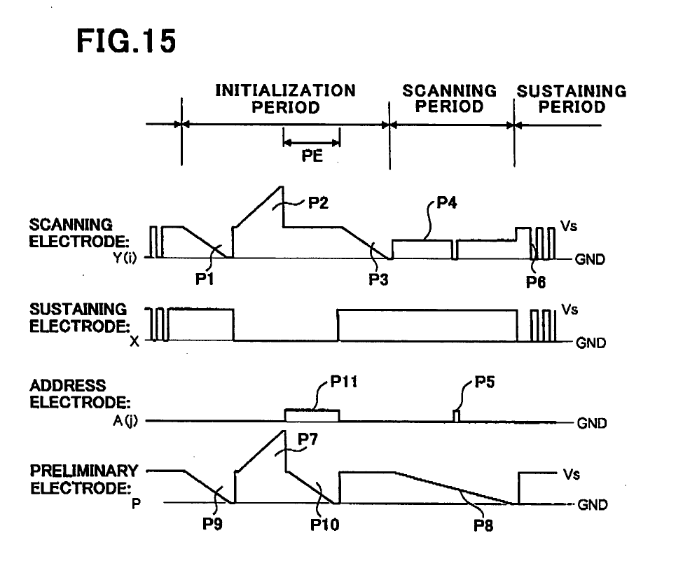

FIG. 15 illustrates waveforms of voltages to be applied to electrodes in a plasma display panel in accordance with the eighth embodiment.

Hereinbelow is explained a method of driving the plasma display panel in accordance with the eighth embodiment, with reference to FIG. 15. The plasma display panel in accordance with the eighth embodiment is structurally identical with the plasma display panel in accordance with the first embodiment, illustrated in FIG. 5.

A method of driving the plasma display panel in accordance with the eighth embodiment is different from the method of driving the plasma display panel in accordance with the first embodiment in having a period PE for eliminating opposing electric charges, between the preliminary discharge pulse P2 and the preliminary-discharge eliminating pulse P3 in the initialization period.

In the period PE for eliminating opposing electric charges, an electric-charge eliminating pulse P10 having the same inclination as that of the preliminary-discharge eliminating pulse P3 applied to the scanning electrode 2 is applied to the preliminary electrode 5, and further, a positive pulse P11 having the same voltage as that of the address pulse P5 is applied to the address electrode 4 to thereby generate electric discharge between the preliminary electrode 5 and the address electrode 4.

Since the sustaining electrode 3 is kept grounded in the period PE for eliminating opposing electric charges, no electric discharges are generated between the sustaining electrode 3 and the other electrodes.

Thus, in a supplementary discharge period (that is, the scanning period), electric discharge is not generated between the preliminary electrode 5 and the address electrode 4, but electric discharge is generated only between the preliminary electrode 5 and the sustaining electrode 3.

As mentioned in the seventh embodiment, if electric discharge is generated between the preliminary electrode 5 and the address electrode 4 in the supplementary discharge period, an amount of wall charges accumulated on a portion of the address electrode 4 facing the scanning electrode 2 is varied, and/or priming particles are insufficiently supplied due to varied condition of the electric discharge generated between the preliminary electrode 5 and the sustaining electrode 3.

Thus, in the eighth embodiment, an amount of wall charges accumulated between the preliminary electrode 5 and the address electrode 4 is adjusted prior to the supplementary discharge period such that no electric discharge is generated between the preliminary electrode 5 and the address electrode 4 in the supplementary discharge period. This ensures stable operation of the plasma display panel.

In the method of driving the plasma display panel in accordance with the eighth embodiment, the electric discharge is generated between the preliminary electrode 5 and the address electrode 4 after the preliminary discharge pulse P2 has been applied to the scanning electrode 2, but the preliminary-discharge eliminating pulse P3 is applied to the scanning electrode 2, to thereby adjust an amount of the wall charges, and further, thereby prevent generation of the electric discharge between the preliminary electrode 5 and the address electrode 4. Thus, the plasma display panel in accordance with the eighth embodiment can stably operate.

[Ninth Embodiment]

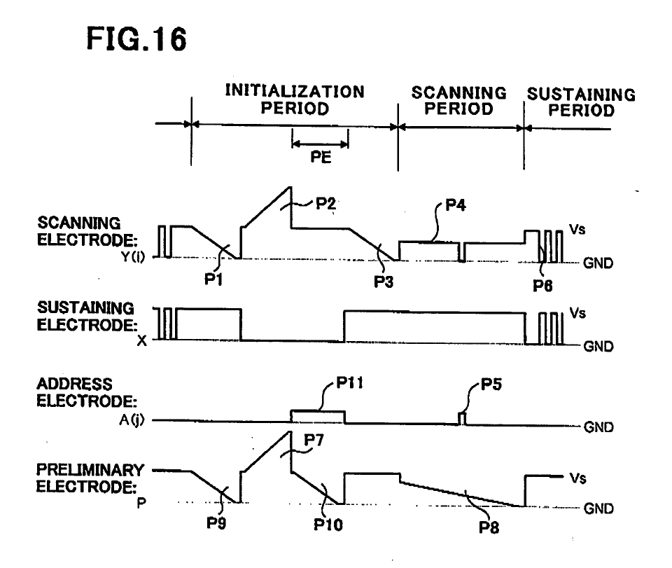

FIG. 16 illustrates waveforms of voltages to be applied to electrodes in a plasma display panel in accordance with the ninth embodiment.

Hereinbelow is explained a method of driving the plasma display panel in accordance with the ninth embodiment, with reference to FIG. 16. The plasma display panel in accordance with the ninth embodiment is structurally identical with the plasma display panel in accordance with the first embodiment, illustrated in FIG. 5.

A method of driving the plasma display panel in accordance with the ninth embodiment is different from the method of driving the plasma display panel in accordance with the eighth embodiment in that the supplementary discharge pulse P8 to be applied to the preliminary electrode 5 in the supplementary discharge period (the scanning period) has a lower initial voltage than an initial voltage of the supplementary discharge pulse P8 in the eighth embodiment.

Specifically, whereas the supplementary discharge pulse P8 in the eighth embodiment has an initial voltage of Vs, the supplementary discharge pulse P8 in the ninth embodiment has an initial voltage lower than Vs.

Even if a pulse having an inclined waveform is applied to an electrode, there is not generated electric discharge, if a voltage exceeds a threshold voltage. Accordingly, in the beginning of the scanning period, there is not generated weak electric discharge between the preliminary electrode 5 and the sustaining electrode 3.

Thus, in the ninth embodiment, a period of time necessary for the weak electric discharge to start is shortened by lowering an initial voltage of the supplementary discharge pulse P8. As a result, there is generated the supplementary electric discharge even in the former half of the scanning period, ensuring that a discharge-delay time is shortened due to the supplementary electric discharge even in the former half of the scanning period.

Furthermore, it is possible to start the weak electric discharge immediately after the scanning period started, by starting the weak electric discharge sooner than the eighth embodiment. Thus, it is possible to keep the supplementary electric discharge generated substantially during the scanning period.

In method of driving the plasma display panel in accordance with the ninth embodiment, the supplementary discharge pulse. P8 to be applied to the preliminary electrode 5 in the supplementary discharge period (the scanning period) has a lower initial voltage than an initial voltage of the supplementary discharge pulse P8 in the eighth embodiment. As a result, it is possible to start the weak electric discharge sooner than the eighth embodiment, and the supplementary electric discharge can be generated even in the former half of the scanning period, ensuring that a discharge-delay time is shortened due to the supplementary electric discharge even in the former half of the scanning period.

[Tenth Embodiment]

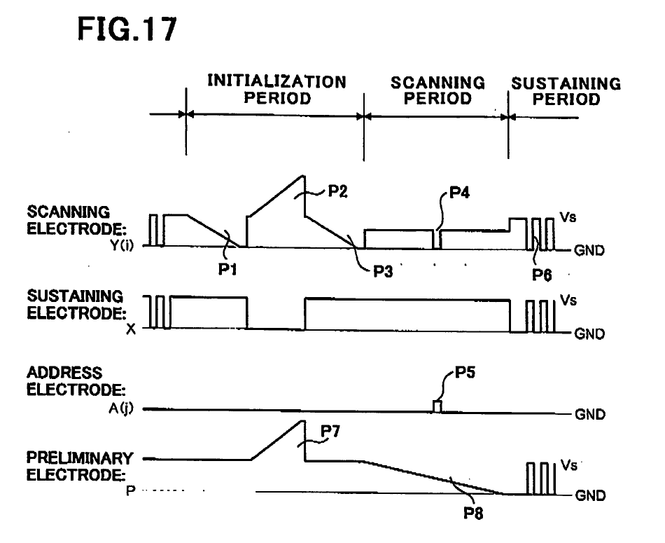

FIG. 17 illustrates waveforms of voltages to be applied to electrodes in a plasma display panel in accordance with the tenth embodiment.

Hereinbelow is explained a method of driving the plasma display panel in accordance with the tenth embodiment, with reference to FIG. 17. The plasma display panel in accordance with the tenth embodiment is structurally identical with the plasma display panel in accordance with the sixth embodiment, illustrated in FIG. 12.

A method of driving the plasma display panel in accordance with the tenth embodiment is different from the method of driving the plasma display panel in accordance with the first embodiment in that the preliminary electrode 5 has the same voltage as that of the sustaining electrode 3 in the sustaining period.

The method of driving the plasma display panel in accordance with the tenth embodiment makes it possible to reduce wasteful power not contributing to generation of electric discharges, in comparison with the method of driving the plasma display panel in accordance with the first embodiment.

Wasteful power is dependent on an electrostatic capacity and a voltage of a plasma display panel, and a number of variance in a voltage between electrodes, Most of the wasteful power is consumed in the sustaining period in which a number of variance in a voltage between electrodes is higher than the same in the initialization and scanning periods. Hence, it is possible to reduce wasteful power consumption by setting a voltage of the preliminary electrode 5 equal to a voltage of the sustaining electrode 3 in the sustaining period to thereby accomplish no difference in a voltage between the preliminary electrode 5 and the sustaining electrode 3.

Since a voltage to be applied to the preliminary electrode 5 in the sustaining period in which electric discharges contributing to a display brightness are generated is set equal to a voltage of the sustaining electrode 3 in the method of driving the plasma display panel in accordance with the tenth embodiment, it is possible to reduce wasteful power not contributing to generation of electric discharges, in comparison with the method of driving the plasma display panel in accordance with the first embodiment.

[Eleventh Embodiment]

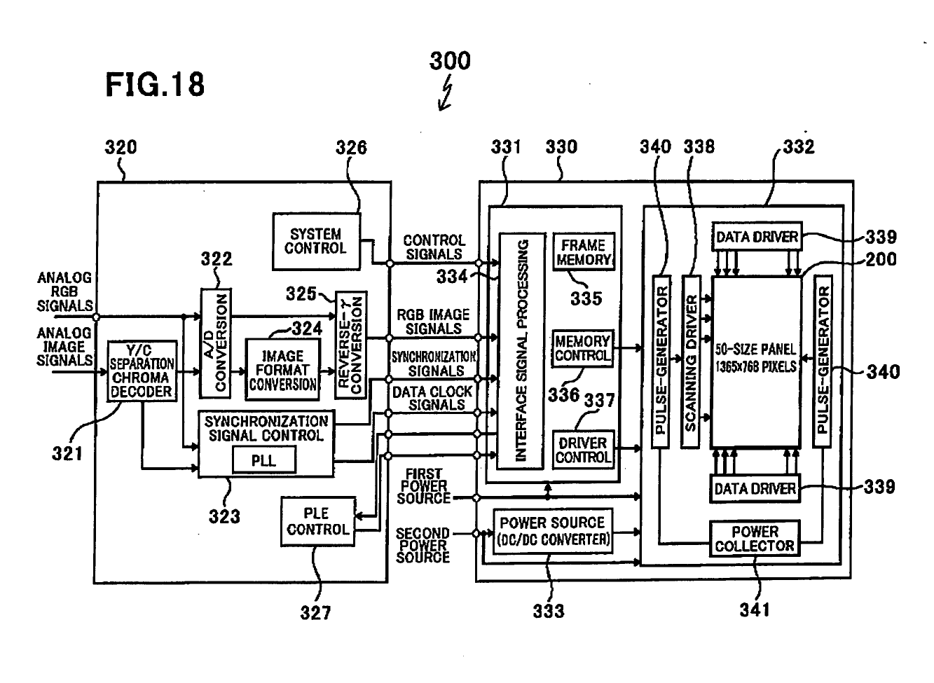

FIG. 18 is a block diagram of a plasma display unit 300 including the plasma display panel in accordance with any one of the above-mentioned first to tenth embodiments.

As illustrated in FIG. 18, the plasma display unit 300 has a modularized structure, Specifically, the plasma display unit 300 is comprised of an analog interface 320 and a plasma display panel module 330.

The plasma display panel module 330 includes a plasma display panel 200 comprised of the plasma display panel in accordance with any one of the above-mentioned first to tenth embodiments.

The analog interface 320 is comprised of a Y/C separating circuit 321 including a chroma-decoder, an analog-digital (A/D) converting circuit 322, a circuit 323 for controlling a synchronization signal, including a phase-lock loop (PLL) circuit, a circuit 324 for converting an image format, an reverse-gamma converting circuit 325, a system control circuit 326, and a PLE control circuit 327.

In brief, the analog interface 320 coverts a received analog image signal into a digital image signal, and then, outputs the digital image signal to the plasma display panel module 330.

For instance, an analog image signal transmitted from a television tuner (not illustrated) is separated into luminance signals for RGB colors in the Y/C separating circuit 321, and then, converted into an RGB digital signal in the A/D converting circuit 322.

Then, if a pixel configuration in the plasma display panel module 330 is different from a pixel configuration of the image signal, necessary conversion of image format is carried out in the image-format converting circuit 324.

A characteristic of a luminance to a signal input to a plasma display panel is linear. Image signals are usually compensated for, specifically, gamma-converted in advance in accordance with characteristics of a cathode ray tube (CRT). Hence, after the image signals are A/D-converted in the A/D converting circuit 322, reverse-gamma conversion is applied to the image signals are in the reverse-gamma converting circuit 325 for producing digital image signals having linear characteristics. The thus produced digital image signals are output to the plasma display panel module 330 as RGB image signals.

Since an analog image signal does not include a sampling clock signal and a data clock signal used for A/D conversion, the PLL circuit included in the control circuit 323 produces a sampling clock signal and a data clock signal, based on a horizontal synchronization signal provided together with the analog image signal, and outputs the clock signals to the plasma display panel module 330.

The PLE control circuit 327 carries out luminance brightness) control. Specifically, if an average picture level is equal to or smaller than a threshold level, a luminance for displayed images is raised, and if an average picture level is greater than a threshold level, a luminance is reduced.

The system control circuit 326 outputs various control signals to the plasma display panel module 330.

The plasma display panel module 330 is comprised of a digital signal processing and controlling circuit 331, a panel section 332, and a power source circuit 333 including a DC/DC converter.

The digital signal processing and controlling circuit 331 is comprised of an input interface signal processing circuit 334, a frame memory 335, a memory control circuit 336, and a driver control circuit 337.

The interface signal processing circuit 334 receives various control signals transmitted from the system control circuit 326, an RGB image signal transmitted from the reverse-gamma converting circuit 325, a synchronization signal transmitted from the control circuit 323, and a data clock signal transmitted from the PLL circuit.

For instance, an average picture level (APL) of an image signal input into the interface signal processing circuit 334 is calculated in an APL calculating circuit (not illustrated) included in the input interface signal processing circuit 334, and output as 5-bit data, for instance. The PLE control circuit 327 arranges PLE control data in accordance with the calculated average picture level, and outputs the PLE control data to a picture level control circuit (not illustrated) included in the input interface signal processing circuit 334.

The digital signal processing and controlling circuit 331 processes those signals in the input interface signal processing circuit 334, and then, transmits a control signal to the panel section 332. The memory control circuit 336 transmits a memory control signal to the panel section 332, and the driver control circuit 337 transmits a driver control signal to the panel section 332.

The panel section 332 is comprised of a 50-size plasma display panel 200, a scanning driver 338 for driving a scanning electrode of the plasma display panel 200, data drivers 339 for driving data electrodes of the plasma display panel 200, pulse-generating circuits 340 for applying a pulse voltage to the plasma display panel 200 and the scanning driver 338, and a circuit 341 for collecting excess power supplied from the pulse-generating circuits 340.

The plasma display panel 200 is designed to have 1365×768 pixels, for instance. In the plasma display panel 200, the scanning driver 338 controls a scanning electrode, and the data drivers 339 control data electrodes (address electrodes), thereby a light is emitted from selected display cells for displaying images.

A first power source supplies power to the digital signal processing and controlling circuit 331 and the panel section 332. A power source circuit 333 receives DC power from a second power source, converts a DC voltage into a desired voltage, and supplies the desired voltage to the panel section 332.

Hereinbelow is explained a method of fabricating the plasma display unit 300.

First, the plasma display panel 200, the scanning driver 338, the data drivers 339, the pulse-generating circuits 340, and the power-collecting circuit 341 are arranged on a substrate to thereby fabricate the panel section 332.

Apart from the panel section 332, there is fabricated the digital signal processing and controlling circuit 331.

The panel section 332, the digital signal processing and controlling circuit 31 and the power source circuit 333 are assembled as a module. Thus, the plasma display panel module 330 is completed.

Apart from the plasma display panel module 330, there is fabricated the analog interface 320.

After the plasma display panel module 330 and the analog interface 320 have been fabricated separately from each other, they are electrically connected to each other. Thus, there is completed the plasma display unit 300 illustrated in FIG. 18.

By modularizing the plasma display unit 300, the plasma display panel 200 can be fabricated independently of other parts constituting the plasma display unit 300. For instance, if the plasma display panel 200 went wrong in the plasma display unit 300, the plasma display panel module 330 including the plasma display panel 200 having gone wrong can be exchanged into new one, ensuring simplification in repair and reduction in time for repair.

Furthermore, since the plasma display unit 300 includes the plasma display panel in accordance with one of the first to tenth embodiments, the plasma display unit 300 can have advantages provided by the plasma display panel in accordance with one of the first to tenth embodiments.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2005-284548 filed on Sep. 29, 2005 including specification, claims, drawings and summary is incorporated herein by reference in its entirety.

What is claimed is:

1. A method of driving a plasma display panel including (a) a first electrode, (b) a second electrode extending in parallel with said first electrode to define a display line therebetween, and (c) a third electrode extending crossing with said first and second electrodes, display cells being defined at intersections of said first and second electrodes with said third electrode, display control being carried out to said display cells in dependence on whether there occurs electric discharge caused by applying a selection pulse to said first and third electrodes in a scanning period,
the method comprising:
providing a fourth electrode which causes preliminary electric discharge together with one of said first, second and third electrodes; and
keeping said preliminary electric discharge caused during a discharge period for at least two display lines in said scanning period.

2. The method as set forth in claim 1, wherein said preliminary electric discharge is kept caused during said discharge period for at least a half of display lines in said scanning period.

3. The method as set forth in claim 1, wherein said preliminary electric discharge is kept caused in a latter half of said scanning period.

4. The method as set forth in claim 1, wherein said preliminary electric discharge is kept caused substantially entirely during said scanning period.

5. The method as set forth in claim 1, wherein after said preliminary electric discharge has once started, said preliminary electric discharge is kept caused until said scanning period terminates.

6. The method as set forth in claim 1, wherein said preliminary electric discharge is caused between said second and fourth electrodes.

7. The method as set forth in claim 1, wherein said fourth electrode extends in parallel with said second electrode.

8. The method as set forth in claim 1, wherein a pulse having a voltage varying with the lapse of time is applied to said fourth electrode in said scanning period.

9. The method as set forth in claim 1, wherein said plasma display panel includes a plurality of said fourth electrodes, and wherein a pulse having a fixed voltage waveform is commonly applied to said fourth electrodes.

10. The method as set forth in claim 1, wherein at least one of voltages to be applied to said fourth electrode is identical with a voltage to be applied to said first electrode, and is supplied from a voltage source which supplies voltages to said first electrode.

11. The method as set forth in claim 10, wherein a preliminary discharge pulse for initializing said display cells is applied to said first electrode, and a pulse identical with said preliminary discharge pulse is applied to said fourth electrode at a timing identical with a timing at which said preliminary discharge pulse is applied to said first electrode.

12. The method as set forth in claim 10, wherein a discharge-eliminating pulse for eliminating or adjusting electric charges of a display cell in which there occurred electric discharge contributing to a display brightness is applied to said first electrode, and a pulse identical with said discharge-eliminating pulse is applied to said fourth electrode at a timing identical with a timing at which said discharge-eliminating pulse is applied to said first electrode.

13. The method as set forth in claim 8, wherein a preliminary discharge pulse for initializing said display cells is applied to said first electrode, and a voltage to which said pulse applied to said fourth electrode finally reaches is identical with a voltage to which a preliminary discharge-eliminating pulse to be applied to said first electrode after said preliminary discharge pulse was applied to said first electrode finally reaches.

14. The method as set forth in claim 1, wherein a voltage to be applied to said fourth electrode in a period in which there is caused electric discharge for contributing to a display brightness is identical with a voltage of said second electrode in the same period.

15. The method as set forth in claim 13, wherein electric discharge is caused between said third and fourth electrodes after said preliminary discharge pulse is applied to said first electrode, but before said preliminary discharge-eliminating pulse is applied to said first electrode.

16. The method as set forth in claim 15, wherein a voltage to be applied to said fourth electrode after said preliminary discharge pulse is applied to said first electrode, but before said preliminary discharge-eliminating pulse is applied to said first electrode has a waveform identical with a waveform of said preliminary discharge-eliminating pulse to be applied to said first electrode.

17. A plasma display panel including:
(a) a first electrode;
(b) a second electrode extending in parallel with said first electrode to define a display line therebetween;
(c) a third electrode extending crossing with said first and second electrodes; and
(d) a fourth electrode which causes preliminary electric discharge together with one of said first, second and third electrodes,
wherein display cells are defined at intersections of said first and second electrodes with said third electrode,
display control is carried out to said display cells in dependence on whether there occurs electric discharge caused by applying a selection pulse to said first and third electrodes in a scanning period, and
said preliminary electric discharge is kept caused during a discharge period for at least two display lines in said scanning period.

18. The plasma display panel as set forth in claim 17, wherein said second electrode is comprised of a first area and a second area,
electric discharge being caused between said first area and said first electrode, and electric discharge being caused between said second area and said fourth electrode.

19. The plasma display panel as set forth in claim 18, wherein said first and second areas are separated by a slit from each other such that electric discharge between said first area and said first electrode is caused independently of electric discharge caused between said second area and said fourth electrode.

20. The plasma display panel as set forth in claim 18, further comprising a partition wall extending in a row direction to separate display cells located adjacent to each other from each other,
wherein said second electrode extends crossing said partition wall,
a portion of said second electrode located at one side about said partition wall defines said first area, and a portion of said second electrode located at the other side about said partition wall defines said second area.

21. The plasma display panel as set forth in claim 20, wherein two partition walls extending in a row direction and disposed adjacent to each other define a first discharge space in which sustaining discharge is generated and a second discharge space in which preliminary discharge is generated.

22. The plasma display panel as set forth in claim 17, wherein said fourth electrode is arranged every other display line.

23. The plasma display panel as set forth in claim 22, wherein two first electrodes and two second electrodes are alternately arranged.

24. The plasma display panel as set forth in claim 17, further comprising a partition wall extending in a column direction to separate display cells located adjacent to each other from each other,
wherein a portion of said third electrode facing said fourth electrode is spaced away from said fourth electrode through said partition wall.

25. A plasma display unit comprising:
a plasma display panel; and
a driver circuit for driving said plasma display panel,
said plasma display panel including:
(a) a first electrode;
(b) a second electrode extending in parallel with said first electrode to define a display line therebetween;
(c) a third electrode extending crossing with said first and second electrodes; and
(d) a fourth electrode which causes preliminary electric discharge together with one of said first, second and third electrodes,
wherein display cells are defined at intersections of said first and second electrodes with said third electrode,
display control is carried out to said display cells in dependence on whether there occurs electric discharge caused by applying a selection pulse to said first and third electrodes in a scanning period, and
said preliminary electric discharge is kept caused during a discharge period for at least two display lines in said scanning period.

26. The plasma display unit as set forth in claim 25, wherein said second electrode is comprised of a first area and a second area,
electric discharge being caused between said first area and said first electrode, and electric discharge being caused between said second area and said fourth electrode.

27. The plasma display unit as set forth in claim 26, wherein said first and second areas are separated by a slit from each other such that electric discharge between said first area and said first electrode is caused independently of electric discharge caused between said second area and said fourth electrode.

28. The plasma display unit as set forth in claim 26, wherein said plasma display panel further includes a partition wall extending in a row direction to separate display cells located adjacent to each other from each other,
said second electrode extends crossing said partition wall, and
a portion of said second electrode located at one side about said partition wall defines said first area, and a portion of said second electrode located at the other side about said partition wall defines said second area.

29. The plasma display unit as set forth in claim 28, wherein two partition walls extending in a row direction and disposed adjacent to each other define a first discharge space in which sustaining discharge is caused and a second discharge space in which preliminary discharge is caused.

30. The plasma display unit as set forth in claim 25, wherein said fourth electrode is arranged every other display line.

31. The plasma display unit as set forth in claim 30, wherein two first electrodes and two second electrodes are alternately arranged.

32. The plasma display unit as set forth in claim 25, wherein said plasma display panel further includes a partition wall extending in a column direction to separate display cells located adjacent to each other from each other, and a portion of said third electrode facing said fourth electrode is spaced away from said fourth electrode through said partition wall.
